(19) United States
(12) Patent Application Publication
(10) Pub. No.: US 2002/0085763 A1
(43) Pub. Date: Jul. 4, 2002

(54) Method, arrangement, and system for ascertaining process variables

(76) Inventor: Frank Olschewski, Heidelberg (DE)

Correspondence Address: DAVIDSON, DAVIDSON & KAPPEL, LLC, 485 SEVENTH AVENUE, 14TH FLOOR, NEW YORK, NY, 10018, US

(21) Appl. No.: 10/023,490

(22) Filed: Dec. 17, 2001

(30) Foreign Application Priority Data
Dec. 30, 2000 (DE) DE100 65 783.4-52

(51) Int. Cl. G06K 9/62

(52) U.S. Cl. 382/224

(57) ABSTRACT

The invention discloses a method, an arrangement, and a system for ascertaining process variables. The method is characterized by multiple steps. The intensities ascertained by a plurality of detectors from different spectral regions of a measurement operation are combined into one intensity vector (\overline{I}). A norm of the intensity vector (\overline{I}) is calculated therefrom. Those intensity vectors whose norm is less than a definable threshold value (SW) are then discarded. The intensity vectors (\overline{I}) are normalized. Processing of the intensity vectors (\overline{I}) is accomplished in a vector quantizer (58). Lastly, code book vectors are read out of the vector quantizer (58).

### CROSS REFERENCE TO RELATED APPLICATIONS

This invention claims priority of the German patent application 100 65 783.4 which is incorporated by reference herein.

### FIELD OF THE INVENTION

The invention concerns a method for ascertaining process variables. These are, in particular, process variables that are not directly measurable, are based on local correlations, and occur upon analysis and display of the data ascertained in fluorescence microscopy.

The invention additionally concerns an arrangement for carrying out the method for ascertaining said process variables during operation of a fluorescence microscope, incorporation into a system, and utilization in applications.

The invention furthermore concerns a system for ascertaining process variables in a microscope system. In particular, the system concerns a scanning microscope that guides light in parallel or sequential fashion over a specimen; multiple detectors that ascertain, from the light proceeding from the specimen, intensities from different spectral regions; a processing unit; a computer; an input unit; and a display, which coact in suitable fashion.

This arrangement will be described below in more detail, with no limitation of its generality, with reference to a confocal scanning microscope, it being sufficiently clear to those skilled in the art that other forms of scanning microscopes (e.g. CCD-based), spectroscopes, or related measuring instruments can be used.

### BACKGROUND OF THE INVENTION

Internal process parameters that must be characterized by correlation occur frequently in fluorescence microscopy. The purpose of creating images in immunofluorescently stained structures in a specimen is to unequivocally identify dyes within the volume defined by the specimen. The state within a sufficiently small sample volume can be described mathematically as a vector of concentrations=\overline{ρ}=(ρ₁ . . . ρₙ). Physically, a suitable excitation in the specimen causes the vector of concentrations \overline{ρ}=(ρ₁ . . . ρₙ) to be converted into a light signal with a continuous spectrum, optically broken down into different bands, spectrally weighted (e.g. by way of optical filter systems), and directed sequentially or in parallel fashion onto a detector or multiple detectors. The detector can be a photosensor or an array having multiple photosensors (CCD chips are used when wide dynamics are not absolutely necessary). In this fashion, multiple intensities Iᵢ are detected from the relevant sample volume and, if local coordinates are simultaneously recorded, can be used for image production. The individual intensities Iᵢ of a sample volume can be summarized as a vector \overline{I}=(Iᵢ . . . I_{q}) which hereinafter, with no limitation as to generality, is sorted by increasing wavelength (decreasing energy) within the vector, and represents the totality of the information acquired at a point.

The image creation properties in the context of immunofluorescently stained structures can be presented, according to the existing art, as follows:

The elements participating in the information chain are substantially linear, so that the entire information chain can be described, to a good approximation, as a linear merging problem where \overline{I}=M\overline{ρ}+\overline{n}, in which \overline{n} describes the noise and the merging matrix M is a q×n matrix. In this approximation, merging processes between specimen volumes due to the low-pass characteristics of the optical system are ignored. The variable of interest to the user is \overline{n}; the measurable variable is \overline{I}. The noise can be divided into the following components: autofluorescence, light-induced noise, and electronic noise. The merging matrix M is a priori unknown, since many sections of the information chain referred to (such as the exact profile of spectra given the chemical environmental parameters, component tolerances, etc.) are insufficiently known at the time of measurement. In microscopy, because of the limited number of detectors, it is usually true that q<n. This means that M usually results in an irreversible information reduction. In spectroscopy, more information is retained because the dimension of the acquired vector is larger.

In the immunological staining process that is often used, the structures observed are equipped with different stains. Only a limited, discrete quantity of antibodies can be associated with each structure itself. As a result, these structures create fixed relationships among the components of the vector \overline{ρ}. For this reason, all structures having the same stain bonds lie on a straight line through the origin in the concentration space, and are imaged by the optical image (the merging matrix M) on straight lines through the origin in the intensity space. The straight line is usually retained; if q<n, the projection yields M\overline{ρ}₁ as the result, but occasionally it produces very small slopes (poor numerical definition) or indeed the zero vector (total information loss).

For this reason, data sets in microscopy can be broken down into multiple subsets that differ in terms of local correlation (slopes of the straight lines in the intensity space). Localization of the straight lines in the intensity space provides information about the material in the sample volume; the position of the measured value on the line provides information about quantity.

This model of image creation is accepted and current existing art, and is expressed in several embodiments with practical applications.

In the multicolor analysis method described by Demandolx and Davoust, biological structures are localized by the introduction of individual stains (see Demandolx, Davoust: Multicolor Analysis and Local Image Correlation in Confocal Microscopy, Journal of Microscopy, Vol. 185, part 1, January 1997, pp. 21-36). If a structure reacts to one stain, the term “localization” is used. If a structure reacts to more than one stain simultaneously, the term “co-localization” is used, and the number of straight lines observed in the intensity vector space is greater than the number of stains. This state of affairs is made visible by sophisticated visualization during analysis. The cytofluorogram technique introduced by Demandolx and Davoust visualizes an ensemble of two-dimensional intensities {\overline{I}} (in microscopy, the pixels of an image, voxels of a volume, or a temporally sequential series thereof, in cytofluorometry, the measurements of multiple samples) as a two-dimensional scatter plot that essentially depicts a two-dimensional frequency distribution. On this basis, an estimate is produced of the overall probability function of the intensities \overline{I}, a \overline{I}=M\overline{ρ}+\overline{n} method which is existing art in mathematical data analysis and whose quality depends only on the size of the ensemble. With appropriate color coding and graphical display, an image of the intensity distribution is produced in which the straight lines are to be localized by the user's eye as widened tracks. The widening exists as a result of all the noise forms and any chemical influences at work in the background.

This technique has been widely used in microscopy, and also applies to this invention. By ascertaining the straight lines with the most intense expression (frequency), for example, one obtains the information that the user actually wanted to measured and that corresponds to the stains that were applied. Any kind of obliquity represents a falsification of information, caused by parasitic spectral crosstalk phenomena that cannot be entirely eliminated in the design of optical elements and fluorescent samples. Once the position is known, the information present in the intensities can be separated out again using simple arithmetic operations. The entire procedure is often implemented on the computer screen with a graphical user interface, in which lines that are adapted by the user to the observed tracks of the straight lines are overlaid on the cytofluorogram display. Correction of the measured data can be accomplished with a simple software program that derives the correction operation from the position of the straight lines. On the other hand, if closed graphical models (regions of interest) are overlaid on the cytofluorogram, a binary segmentation of co-localized regions can be achieved. An expansion of the cytofluorogram concept to three channels is also possible, and has been implemented for some time in the special Leica product software for confocal and multi-photon systems (LCS=Leica Confocal Software).

The existing method has disadvantages that are compensated for by this invention. Although the methods are graphical, they depend very strongly on the user's visual capabilities. This results in a subjective falsification of every measurement made, depending exclusively on the user's ability to work with the system; performance in terms of reproducibility is therefore poor. The analysis of multi-channel images results in further problems, since the visualization of higher-dimensional intensity distributions (cytofluorograms, scatter plots) cannot be performed directly. Projections and similar artifices, which are difficult to interpret in practice, must be resorted to in such cases. Even a three-channel implementation is difficult in practical terms for some users, since interpretation of the measured data demands an ability to conceptualize in three dimensions. The invention creates an improvement here as well. In addition, the cytofluorogram-based methods manipulate large data quantities en bloc, which makes them impossible to use during the measurement operations. These are not on-line algorithms, since too many calculations and data manipulations are involved; no economical computer model is available, and in electronics, these tasks cannot be performed on the fly. For this reason, the adjustment algorithms based on these methods, which are possible and necessary as discussed below, also cannot be implemented economically.

The measurement model described above is also needed in order to perform system adjustments to the microscope system on an active basis. The configuration and design of fluorescent microscopes, complex microscopy systems, and spectroscopy systems can be graphically elucidated using the above model. A good microscope design aims at a merging matrix M in the form of a diagonal matrix. This corresponds to a 1:1 correlation between the detectors and the stains that are to be detected. The measured channels should then be as independent as possible during the measurement. In graphical terms, this means that the images of the straight lines should be as vertical as possible.

Design criteria for achieving this goal include, for example, the selection of lasers, optical filters, detectors, or, in the case of the SP2 module developed by Leica, predefined filter macros for spectral separation intended to achieve the aforementioned diagonalization. Suitable configuration of such elements brings one closer to this goal.

For this purpose, German patent application DE-A-198 29 944 discloses a capability for finding a possible device configuration on the basis of a database by inference (logical conclusions). Because all these methods can operate only with limited prior knowledge, however, this goal can be only partly attained.

Multiple excitations, spectral crosstalk, tolerances in and aging of the subassemblies used, limited cutoff slope of optical filters, and physical/chemical environmental parameters (pH, temperature, age and responsiveness of biological specimens) all exert additional influences that must inherently be ignored by configuration methods of this kind because of the absence of a priori knowledge. Spectral crosstalk alone causes M to degenerate into a triangular matrix. Additional error sources quickly result in a completely occupied matrix M in which, however, the upper triangular matrix should have very much lower values than the lower triangular matrix. The result is that the images of the straight lines run not vertically, but obliquely. All methods based only on interference therefore remain incomplete. In order for configuration to be improved starting from this kind of suboptimal setting, the position of the straight lines must be measured as a process parameter. For these process parameters or combinations/pairs of process parameters, it is possible to indicate the target states (orthogonality) for which the microscope settings are optimum and therefore also furnish optimum data or image information about the specimen being examined. This is a relatively simple task, since according to the existing art optimization tasks of this kind can be easily performed using a number of different methods if the present situation, and what is wanted, are known (cf. for example Michaelewicz, Fogel, How to Solve It: Modern Heuristics. Berlin, Springer, 2000). For such purposes, this invention achieves, inter alia, the object of adequately quantifying the internal processes in real time, making the actual and reference states determinable, and making these optimization methods accessible. In addition, the mechanisms described in the method have the properties (e.g. monotonic error functions) necessary for their optimum utilization in optimization tasks.

### SUMMARY OF THE INVENTION

It is the object of the present invention to create a method for ascertaining local correlation that makes it possible to process large data quantities in real time. In addition, all the acquired data are employed for analysis, and the user is enabled to examine the specimens efficiently and conveniently in terms of these correlation values. This object is achieved by a method which is characterized by the following steps:

a) combining into one intensity vector the intensities ascertained by a plurality of detectors from different spectral regions of a measurement operation;

b) calculating a norm of the intensity vector;

c) discarding those intensity vectors whose norm is less than a definable threshold value, so that said vectors are left out of consideration in the remainder of the method;

d) normalizing the intensity vectors;

e) delivering the intensity vectors to a vector quantizer and processing the intensity vectors using the vector quantizer;

f) reading code book vectors out of the vector quantizer.

A further object of the invention is to create an arrangement for ascertaining local correlation which permits large data quantities to be processed in real time, employs all acquired data for analysis, and allows the user to examine the specimens efficiently. In addition, settings are determined with the arrangement, microscope configuration setting steps being deduced on the basis of representations of tracks of local correlations and their deviation from the ideal.

The aforesaid object is achieved by an arrangement for ascertaining process variables in a microscope system characterized by:

a) means for combining into one intensity vector the intensities ascertained by a plurality of detectors from different spectral regions of a measurement operation;

b) means for calculating a norm of the intensity vector;

c) means for discarding those intensity vectors whose norm is less than a definable threshold value;

d) means for normalizing the intensity vectors;

e) a vector quantizer that processes the intensity vectors; and

f) means for reading code book vectors out of the vector quantizer.

An additional object of the invention is to create a microscope system for ascertaining local correlation that permits large data quantities to be processed in real time, that employs all acquired data for analysis, and that allows the user to examine the specimens efficiently.

This object is achieved by a microscope system which is characterized in that

a) means for combining into one intensity vector the intensities ascertained by a plurality of detectors from different spectral regions of a measurement operation;

b) means for calculating a norm of the intensity vector;

c) means for discarding those intensity vectors whose norm is less than a definable threshold value;

d) means for normalizing the intensity vectors;

e) a vector quantizer that processes the intensity vectors; and

f) means for reading code book vectors out of the vector quantizer are provided.

An advantage of this invention is that the microscope system is used to point toward a system design by the fact that with a suitable processing unit, representations of the tracks of correlations in the intensity space are ascertained during normal operation and made available to the user. This is done by the fact that the ascertained data are presented to the user in graphical form on a display. Based on the depiction, the user can then make modifications to the settings of the microscope system in order to obtain better analysis of the measured data.

It proves to be particularly advantageous that by way of the measurement rule and a minimal recalculation of the acquired measured data, a number of representations of correlation-based tracks within the measured data are pointed out. These data are referred to hereinafter as “code book vectors.” The method according to the present invention makes possible the correction, in real time, of acquired measured data in terms of expected parasitic measurement errors. For that purpose, a reproducible correction is performed on the basis of representations of tracks of local correlations.

A further advantage of this invention is, among others, the creation of reproducibility.

The microscope system according to the present invention with adaptive correction reduces spectral crosstalk between the individual detection channels and allows large data quantities to be processed in real time. A suitable processing unit ascertains representations of the tracks of correlations in the intensity space during normal operation. The specific correction rule makes it possible to correct the measured data and make them available to the user.

The microscope system moreover possesses the property of material-specific image creation, thus making it possible to process large data quantities in real time. This microscope system possesses a suitable processing unit that ascertains representations of the tracks of correlations in the intensity space during normal operation. A classification of the measured data back onto the correlation representations is also performed, and made available to the user as an image.

A further advantage of the invention is the fact that when a suitable software program is used, the solutions described can be developed into further measurement methods for parameters that cannot be measured directly but can be referred back to tracks of correlations in the intensity space (assuming an appropriately configured intensity space).

In addition, quantification of photodestructive effects is also possible. Time-offset intensities of the same location are examined for representations of local tracks of correlations, and are employed to ascertain the bleaching rate. The microscope system with integrated quantification can moreover display the photodestructive effects. This is made possible by time-delayed delivery of intensity vectors into a real-time-capable processing unit in order to ascertain local correlations, with subsequent quantification of the bleaching rate and presentation on a display.

### BRIEF DESCRIPTION OF THE DRAWINGS

The subject matter of the invention is depicted schematically in the drawings and will be described below with reference to the Figures, in which:

FIG. 1 schematically depicts a system with a confocal microscope;

FIG. 2 is a schematic depiction for implementation of a method for evaluating and setting process variables;

FIG. 3 is a schematic depiction of an implementation of the process for measuring spectral separation quality; and

FIG. 4 is a schematic depiction of an implementation of the process for measuring the bleaching rate.

### DETAILED DESCRIPTION OF THE INVENTION

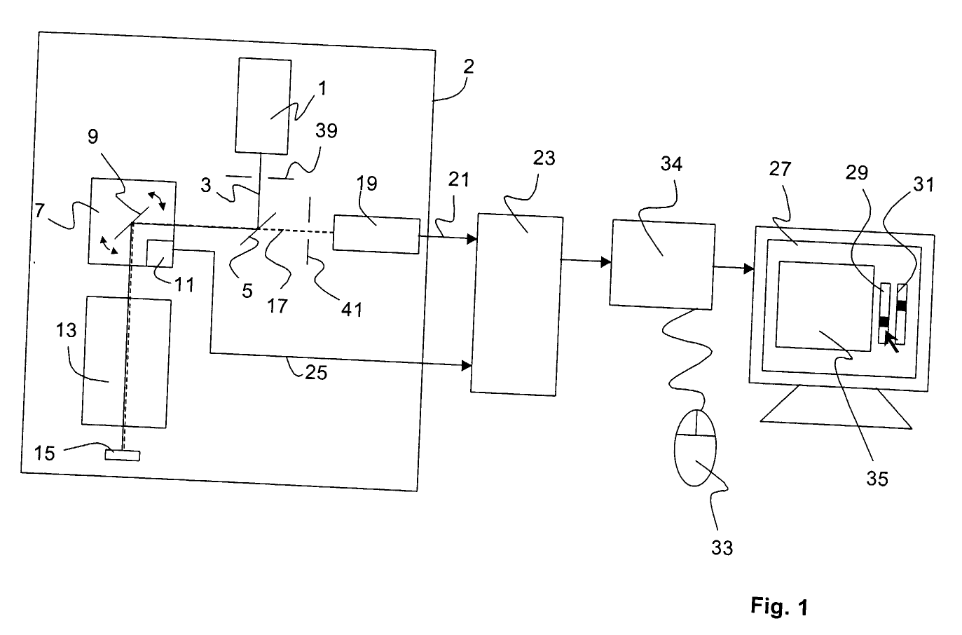

FIG. 1 schematically shows a system with a confocal scanning microscope 2. The description is limited to a confocal scanning microscope 2, but it is clear to anyone skilled in the art that the method according to the present invention is also applicable to other image data acquired by microscopes. Light beam 3 coming from an illumination system 1 is reflected by a beam splitter 5 to scanning module 7, which contains a gimbal-mounted scanning mirror 9 that guides light beam 3 through microscope optical system 13 and over or through specimen 15. In the case of non-transparent specimens 15, light beam 3 is guided over the specimen surface. In the case of biological specimens 15 (preparations) or transparent specimens, light beam 3 can also be guided through specimen 15. This means that different focal planes of specimen 15 are scanned successively by light beam 3. Subsequent assembly then yields a three-dimensional image of specimen 15. Light beam 3 coming from illumination system 1 is depicted as a solid line. Light 17 emerging from specimen 15 passes through microscope optical system 13 and via scanning module 7 to beam splitter 5, passes through the latter, and strikes at least one detector 19, which is embodied as a photomultiplier. If it is possible, for certain applications, to dispense with the wide dynamics of the photomultipliers, CCD sensors are also used as detectors. Light 17 emerging from specimen 15 is depicted as a dashed line. In detector 19, electrical detected signals 21 proportional to the power level of light 17 emerging from the specimen are generated and are forwarded to processing unit 23. Although FIG. 1 depicts only one detector, it is clear to anyone skilled in the art that detector 19 can comprise multiple detectors which each detect individual spectral regions of the light emerging from specimen 15.

Position signals 25 sensed in scanning module 7 with the aid of an inductively or capacitatively operating position sensor 11 are also transferred to processing unit 23. It is self-evident to one skilled in the art that the position of scanning mirror 9 can also be ascertained by way of the displacement signals. The incoming analog signals are first digitized in processing unit 23. The signals are transferred to a computer 34 to which an input unit 33 is connected. By means of input unit 33, the user can make corresponding selections with regard to the processing or depiction of the data. In FIG. 1, a mouse is depicted as an input unit 33. It is self-evident to anyone skilled in the art, however, that a keyboard and the like can also be used as input unit 33. A display 27 depicts, for example, an image 35 of specimen 15, a representation of the ascertained code book vectors in a coordinate system for visualizations of correlation tracks, and the like. In addition, setting elements 29, 31 for image acquisition are depicted on display 27. In the embodiment shown here, setting elements 29, 31 are depicted as sliders. Any other configuration lies within the specialized ability of one skilled in the art. The position signals and detected signals are assembled in processing unit 23 as a function of the particular settings selected, and displayed on display 27. Illumination pinhole 39 and detection pinhole 41 that are usually provided in a confocal scanning microscope are depicted schematically for the sake of completeness. Certain optical elements for guiding and shaping the light beams are, however, omitted in the interest of greater clarity. They are sufficiently familiar to anyone skilled in this art.

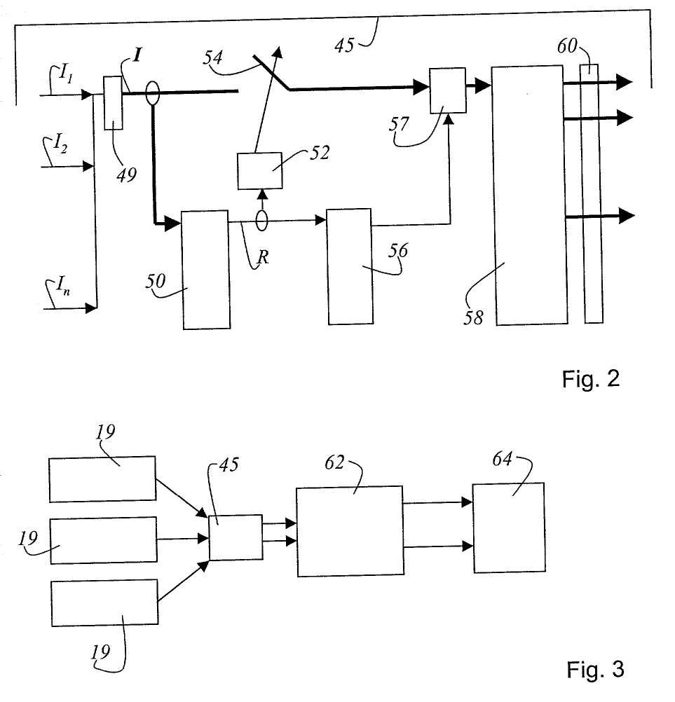

FIG. 2 is a schematic depiction for implementation of a method for evaluating and setting process variables. As already mentioned above, the data regarding the fluorescence properties of specimen 15 under examination are acquired with corresponding detectors 19 and conveyed to various calculation methods. Firstly, the intensities ascertained by a plurality of detectors 19 are conveyed to a means 49 that forms an intensity vector therefrom. The intensity vector \overline{I} is formed from the components I₁, I₂, . . . Iₙ that come from the various spectral regions of a measurement operation. On the basis of a metric, a means 50 is used to calculate the vector norm, and based on that value a decision is made as to whether autofluorescence noise and background, or a usable signal, is present (threshold value test). This is done using a means 50 for calculating the norm of the intensity vector. The test decides whether or not the data vector is a usable signal and is subject to further processing. The Euclidean norm is a good choice here, since it is physically comparable to energies. A generalization to other metrics of linear algebra is, however, possible. The usable signal from detectors 19 is normalized and its dimensionality is reduced. The extracted usable signal is forwarded to a vector quantizer 58 that internally contains a set of intensity vectors which depict the representations of the tracks of local correlation and make them available as the result of the method. The number of vectors present in vector quantizer 58 reflects the behavior expected by the system developer, or is ascertainable (and modifiable) on the basis of the user's a priori knowledge or by way of a suitable software program in computer 34. These vectors are referred to hereinafter as “code book vectors.” The matching of measured values and representations is performed by vector quantizer 58, whose possible modes of operation are described in detail below. The code book vectors, as representations of tracks of local correlation, are read out of vector quantizer 58 with a corresponding means 60.

The method described above is implemented in a device 45. Device 45 compares incoming vectors (intensity vector \overline{I}) to code book vectors, striving always to make the incoming vectors more similar to the code book vectors and to adapt the representations to the input distribution. In the preferred embodiment as depicted in FIG. 2, the measured intensities I₁, I₂, . . . Iₙ are combined into an intensity vector \overline{I}. The intensities I₁, I₂, . . . Iₙ are measured with the at least one detector 19 that is provided in the microscope system. Intensity vector \overline{I} is conveyed to a means 50 for determining the magnitude or for calculating a norm. The magnitude (Euclidean length) R of the vector, which (as mentioned above) is comparable to the energy, is calculated. The intensity vectors \overline{I} are conveyed to a discarding means 52. Only those intensity vectors \overline{I} whose magnitude is greater than a predefined threshold value SW are considered, so that image background, noise, and poorly expressed co-localizations are excluded and are not delivered to the subsequent calculation step. If the magnitude is too low, those intensity vectors \overline{I} are rejected; this is indicated by a switch 54 in FIG. 2. Those intensity vectors \overline{I} that were not rejected are normalized by a normalization unit 56; this is equivalent to projection of an n-dimensional problem onto the (n−1)-dimensional partial surface of the unit hypersphere in the positive quadrant, in which context one position sufficiently describes correlation tracks in the original space. The normalized intensity vectors \overline{I} are conveyed through an additional filter element 57 to the learning-capable vector quantizer 58. The adaptive vector quantizer 58 measures the similarity between the incoming vectors and the vectors from the code book, and makes the most similar ones even more similar. As a result of the initialization and the learning process, vector quantizer 58 tracks the code book vectors in such a way that they approximate the data in the best fashion possible.

Vector quantizers in general constitute the link between continuous vectorial distributions (in this case, intensities) and a discrete world of representations, and are existing art in communications technology and signal processing. Vector quantizers are used in particular for lossy transfer of vectorial signals (cf. for example Moon and Stirling, Mathematical Methods and Algorithms for Signal Processing, London, Prentice Hall, 2000). Vector quantizer 58 that is used here has comparatively few internal code book vectors, since a high degree of compression of the measured data to a very simple model is performed with high loss, and it is adaptive. The incoming intensity vectors are compared simultaneously to all code book vectors, a subset of the most similar code book vectors being selected and adapted. The degree of similarity and the subset are one degree of freedom of the method, and can vary. The selection is made somewhat more similar to the current intensity vector \overline{I}. In the simplest case, this is always only the most similar code book vector. This is accomplished using mathematical methods such as distance measurements with vector norms, local aggregation, or recursive sliding averaging, but the embodiment is different for different types of learning-capable vector quantizers. A number of different methods are possible for an embodiment according to the present invention, and there are a great many degrees of freedom in the real embodiment. The possibilities for embodiment are sufficiently known to those skilled in the art, and will be outlined briefly below.

In addition to the code book design method using classic cluster analysis (cf. Ripley, Pattern Recognition and Neural Networks, Cambridge CUP, 1996)—which is not directly practical here but which we nevertheless do not wish to exclude explicitly—biologically motivated neural networks are a particularly good choice. Luo and Unbehauen propose, among others, a class of competitive-learning neural architectures for the vector quantization task (Luo and Unbehauen, Applied Neural Networks for Signal Processing, Cambridge CUP, 1997). Methods of this kind result from the simulation of representation-forming thought processes by the competitive learning of individual neurons, and create good representations even in the form of a greatly simplified information-technology model. More recent contributions, for example the dissertation of Bernd Fritzke (Bernd Fritzke, Vektorbasierte Neuronale Netze [Vector-based neural networks], Aachen, Shaker, 1998) contain an entire collection of different usable methods that achieve the goal in the context of this contribution. The essential distinguishing criterion is the manner in which the code book vectors are adapted to the intensity distribution that is presented. This adaptation is referred to in the neural network literature as a “learning method.” The property that is essential for this invention, however, is representation formation, with the basic idea of competition of different instances for presented stimuli, and not a suitable mathematical method or a simulation-like approximation to biological processes. The concrete implementation of representation formation, as well as model details such as topologies between representations, retention of topology between representation and intensity space, learning or adaptation rules, etc., are sufficiently familiar to those skilled in the art and are not specified in greater detail in the context of this invention. The most important of these adaptation methods that are based on competitive learning and are known to the inventor are sketched out below, and are evident in detail from the literature.

Direct simulation of competitive learning between neurons can result in one form of vector quantizer 58. For that purpose, the input vector is presented to a number of neurons; a lateral connection among the neurons, weighted so as to reinforce local connections (positive connection) and inhibit more distant ones (negative connection), is also activated. The entire structure is subjected to a Hebbian learning rule that reinforces correlations between inputs and outputs. This type of implementation may be found, as an introductory thought model, in almost all textbooks about neural networks (cf. Haykin, Neural Networks, New York: MacMaster University Press, 1994), and is seldom used for real systems.

So-called “hard” competitive learning initializes the code book vectors randomly with values of sufficient probability. For each normalized intensity \overline{i} conveyed to vector quantizer 58, one winner is identified from the set of code book vectors {\overline{ω}ᵢ} using a rule \overline{ω}=winner(\overline{ω}ᵢ). To minimize errors, the Euclidean distance between stimulus \overline{i} and code book {\overline{ω}ᵢ} is generally used to identify the winner, as defined by

\overline{ω}=min(||\overline{i}−\overline{ω}ᵢ||)

That winner is adapted using the processing rule

\overline{ω}=\overline{ω}+ε(t) (\overline{i}−\overline{ω})

In this context, ε(t) is a learning rate that is often reduced over the operating lifetime of vector quantizer 58. At a constant learning rate, vector quantizer 58 remains adaptive. Using a learning rate inversely proportional to the number of wins results in the so-called “k means” method, which lies exactly in the means of the distribution. By selecting exponentially decreasing learning rates, it is possible to create any desired intermediate states, but other variants are also used.

In so-called “soft” competitive learning, not only the winners but also other code book vectors (possibly even all of them) are adapted.

One instance is the so-called “neural gas” algorithm, in which a ranking is made of the winners on the basis of the winner functions; this also applies to hard competitive learning methods. Based on this ranking, an adaptation function calculates the degree of adaptation, the winner with the best rank being more adapted than a lower-ranked winner. The influence of adaptation is often reduced over time. In a variant called “growing neural gas,” an information-technology or error-minimization criterion is used to increase the number of vectors in the code book until adequate operation is ensured.

In the “self-organizing feature map” version, a topology is overlaid on the code book vectors. During the learning operation, a neighborhood around the winner is always also adapted; nearer neighbors are generally adapted more and more-distant neighbors adapted less, and the influence of neighborhood learning is reduced over time. This is comparable to an X-dimensional rubber membrane that is warped into the distribution without being torn. The advantage of this method is that topological properties are retained.

More recent approaches are characterized by mixed forms, in which topological retention by way of graphs overlaid on the vectors (as in the self-organizing feature map) is combined with growth criteria as in the case of the “growing neural gas.” Examples include “growing cell structures” and the “growing grid.”

In a setup of this kind, the vectors in the code book and the adaptation method are predefined upon initialization before the experiment. This can vary from one application to another. In terms of the loading of vector quantizer 58, there are several variants: One is a vector quantizer 58 that has exactly as many code book vectors as it has channels, and is pre-initialized, in the same sequence as the channels, with orthonormal unit vectors of the channel space. Also conceivable is a vector quantizer 58 that has one orthonormal unit vector for each channel and has one oblique (diagonal in the signal space) unit vector for each possible mixed state. This variant operates in statistically more stable fashion when co-localizations occur. A counter (not depicted), which determines how often a particular code book has been modified, can be used to detect co-localizations. The counter can be employed for simple statistical significance tests, since the number of adaptation steps corresponds to the frequency of corresponding measured values.

FIG. 3 describes the handling and processing of the measured values that are obtained from the several detectors 19. In this exemplary embodiment, detectors 19 are depicted as photomultiplier tubes (PMTs). For evaluation of local correlations, the measured values are delivered from the PMTs to an electronic device 45 that performs the corresponding evaluation as described above. Device 45 is followed by a means 62 for selecting a subset from the plurality of code book vectors. The selected code book vectors are conveyed to an analysis and visualization unit that can be embodied, for example, as display 27 of computer 34. The analysis and visualization unit is connected to a spectrophotometer 64. Spectrophotometer 64 can be configured, for example, as a multiband detector, which identifies crosstalk on the basis of the ascertained correlation representations and performs an automatic tuning in order to minimize the crosstalk of the individual detection channels.

The code book vectors that have been read out are used to evaluate the tuning of spectrophotometer 64. It should be noted in this context that the angle between two code book vectors should ideally be 90°. This fact can be used to calculate a monotonic linear quality function, 0° corresponding to a quality of 0%, and 90° to a quality of 100%. This quality can be used in a tuning algorithm to tune spectrophotometer 64. In this arrangement, device 45 is preferably embodied using FPGA or DSP technology. Analysis can also be performed in computer 34, which can also be used as a control computer; or in the FPGA or DSP, since time behavior is not critical here.

Alternatively, the code book vectors can also be displayed on display 27 so as to inform the user as to the quality of the measurement. The code book vectors being displayed are plotted in a coordinate system. Based on the slope of the code book vectors with respect to the coordinate axes, it is easy to determine the quality of the measurement. Selection of the subset of code book vectors is limited to those code book vectors that are nearest to the axes of a coordinate system, each coordinate axis representing detection in one detection channel of the multiband detector. The slope of the code book vectors with respect to the coordinate axes and to each other is employed to identify crosstalk of the individual detection channels. In the case of two-dimensional selections, this can be utilized directly for visualization. It should also be noted that for visual presentation, a triple depiction of the axes of the coordinate system is also possible; the code book vectors located nearest to said axes can be plotted correspondingly with reference to the coordinate axes.

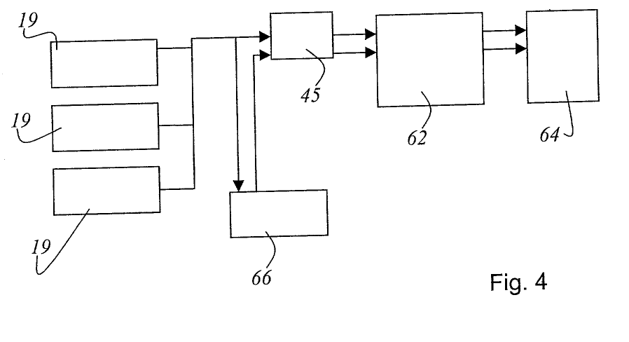

FIG. 4 schematically shows an arrangement that measures the bleaching rate in a specimen 15 being examined. This is done by measuring the same channel at different times in succession, and assembling the vector from the data for the different times. As a result, structures with different bleaching rates are found on different straight lines that are represented by the different vectors. A memory element 66 must be additionally used for this purpose. As depicted in FIG. 4, the values from detectors 19, for example PMTs, are stored. The exemplary embodiment depicted uses three detectors 19, but this is in no way to be regarded as a limitation. The measured data from detectors 19 are always stored in memory element individually for each acquired image. The data of an image that is acquired at time t are always conveyed to device 45 along with the data of the image that was acquired at time t−1. For this purpose, memory element 66 must operate in pixel-synchronized fashion. It is sufficiently known to those skilled in the art that such synchronization can also be accomplished on the basis of lines, frames, or volumes, and needs to be coupled to the scanning motion of light beam 3 in only locally synchronized fashion. One exemplary embodiment is to use a RAM coupled to device 45 as memory element 66; or memory element 66 can be implemented directly in computer 34. As already depicted in FIG. 3, device 45 is followed by means 62 for selecting a subset from the plurality of code book vectors. The selected code book vectors are conveyed to an analysis and visualization unit that can be embodied, for example, as display 27 of computer 34. The bleaching rate can be read off on the basis of the selected code book vectors. The bleaching rate or bleaching behavior can be determined from the slope of a code book vector at time t as compared to the slope of a code book vector at time t+1 in the coordinate system. The information about bleaching rate can also be used for the system settings, since the light sensitivity of the stains present in the sample is ascertained directly. A text presentation to the user by way of display 27 is also conceivable.

With the arrangement of FIG. 4 it is also possible to determine the effect of active system parameters on the measurement. By shifting the system parameters between two measurements, it is possible to draw conclusions as to local changes in the sample, since the correlation values and their representations change. One example is modification of the amount of light on the specimen by modifying the laser output, increasing the AOTF, or attenuating or increasing the pinhole. As long as saturations do not occur, the representations of correlation tracks are retained; they do change in the presence of saturation effects. This is a useful way of finding an optimal setting for the system (e.g. detecting saturation of stains).

The code book vectors moreover essentially contain the information necessary for correcting the measured data. For that purpose, said data must be combined into a matrix and then inverted. The matrix combination procedure can vary depending on whether the goal is information separation or correction of parasitic spectral crosstalk phenomena, which as a rule acts only from higher-energy to lower-energy channels. Inversion of a matrix is existing art. This can be done with an additional electronic component (not depicted) in the data path, or in computer 34. Crosstalk, intensity reduction by bleaching, and combinations thereof are susceptible to correction.

The code book vectors additionally contain information about the material in the sample volume. For that purpose, the measured values are classified back onto the nearest code book entry. Such operations are generally performed in computer 34. If these image data are suitably visualized, the result is a map of different materials in the image. This is not to be confused with the mathematical process of decorrelation used in U.S. Pat. No. 5,719,024, which is performed therein as a pre-processing step. Such a step is not explicitly required here.

It is self-evident that changes and modifications can be made without thereby leaving the range of protection of the claims recited hereinafter.

What is claimed is:

1. A method for ascertaining process variables with a microscope system, the method comprises the following steps:
a) combining into one intensity vector (\overline{I}) the intensities ascertained by a plurality of detectors from different spectral regions of a measurement operation;
b) calculating a norm of the intensity vector (\overline{I});
c) discarding those intensity vectors whose norm is less than a definable threshold value (SW), so that said vectors are left out of consideration in the remainder of the method;
d) normalizing the intensity vectors (\overline{I});
e) delivering the intensity vectors to a vector quantizer and processing the intensity vectors (\overline{I}) using the vector quantizer; and
f) reading code book vectors out of the vector quantizer.

2. The method as defined in claim 1, wherein calculation of the norm is based on the Euclidean distance to a coordinate origin.

3. The method as defined in claim 1, wherein the vector quantizer is embodied as a “learning vector quantizer” or as a competitively learning neural network, or can be derived or inferred therefrom in the context of a mathematical approximation.

4. The method as defined in claim 1, characterized by the following steps:
selecting a subset from the plurality of code book vectors; and
conveying the selected code book vectors to an analysis and visualization unit.

5. The method as defined in claim 4, wherein selection of the subset of code book vectors is limited to those code book vectors that are nearest to the axes of a coordinate system, each coordinate axis representing detection in one detection channel.

6. The method as defined in claim 4, wherein the code book vectors have a slope with respect to the coordinate axes and to each other and the slope is employed to ascertain the crosstalk of the individual detection channels.

7. The method as defined in claim 6, wherein on the basis of the ascertained crosstalk an automatic adjustment of a multi-band detector is performed in order to minimize the crosstalk of the individual detection channels.

8. The method as defined in claim 4, wherein the axes of the coordinate are visually depicted in double or triple fashion, and the code book vectors located nearest to said axes are plotted.

9. The method as defined in claim 4, wherein the axes of the coordinate system are visually depicted in pairs, and the code book vectors located nearest to said axes are plotted.

10. The method as defined in claim 4, wherein a counter that serves to visualize the significance of the signal component represented by the particular code book vector is allocated to each visual depiction of the axes of the coordinate system.

11. The method as defined in claim 1, comprising the following steps:
acquiring the local coordinates in a specimen during the scanning operation, and the intensities (I₁, I₂, . . . Iₙ) associated with the local coordinates;
comparing the intensity vectors (\overline{I}) to the code book vectors; and
classifying the intensity vectors (\overline{I}) onto the nearest code book vector.

12. The method as defined in claim 1, wherein the following steps are performed before steps a) through f):
time-offset, block-based intermediate storage of the intensity vectors; and
formation of vectors from the particular current intensity vector and from the time-offset intensity vector acquired before the particular current and intermediately stored intensity vector, the two vectors deriving from the same location in the specimen.

13. The method as defined in claim 12, wherein the slopes of the code book vectors are analyzed in order to ascertain and visualize the bleaching behavior or influences of active setting parameters.

14. The method as defined in claim 1, wherein the following steps are performed:
calculating a correction matrix from the code book vectors; and
applying the correction matrix to the currently measured intensity vectors with simultaneous image construction.

15. An arrangement for ascertaining process variables in a microscope system, comprises:
a) means for combining into one intensity vector (\overline{I}) the intensities (I₁, I₂, . . . Iₙ) ascertained by a plurality of detectors from different spectral regions of a measurement operation;
b) means for calculating a norm of the intensity vector (\overline{I});
c) means for discarding those intensity vectors whose norm is less than a definable threshold value (SW);
d) means for normalizing the intensity vectors;
e) a vector quantizer that processes the intensity vectors; and
f) means for reading code book vectors out of the vector quantizer.

16. The arrangement as defined in claim 15, wherein the normalizing means perform the calculation of the Euclidean distance to a coordinate origin.

17. The arrangement as defined in claim 15, wherein the vector quantizer is embodied as a “learning vector quantizer” or as a competitively learning neural network, or can be derived or inferred therefrom in the context of a mathematical approximation.

18. The arrangement as defined in claim 15, wherein
means for selecting a subset from the plurality of code book vectors; and
means for conveying the selected code book vectors to an analysis and visualization unit
are provided.

19. The arrangement as defined in claim 18, wherein a multi-band detector is provided that performs an automatic adjustment on the basis of the ascertained crosstalk in order to minimize the crosstalk of the individual detection channels, a selection of the subset of the code book vectors being limited to those code book vectors located nearest to the axes of a coordinate system, each coordinate axis representing detection in one detection channel; and the slope of the code book vectors with respect to the coordinate axes and to one another can be employed to ascertain the crosstalk of the individual detection channels.

20. The arrangement as defined in claim 18, wherein a visual depiction means is provided; and the axes of the coordinates can be depicted in double or triple fashion, and the code book vectors located nearest to said axes can be plotted.

21. The arrangement as defined in claim 18, wherein a visual depiction means is provided; and the axes of the coordinate system can be visually depicted in pairs, and the code book vectors located nearest to said axes can be plotted.

22. The arrangement as defined in claim 18, wherein a counter that verifies the significance of the signal component represented by the particular code book vector is allocated to each visual depiction of the axes of the coordinate system.

23. The arrangement as defined in claim 15, wherein
means for acquiring the local coordinates of a specimen during the scanning operation, and the intensities associated with the local coordinates;
means for comparing the intensity vectors to the code book vectors; and
means for classifying the intensity vectors onto the nearest code book vector
are provided.

24. The arrangement as defined in claim 15, wherein
means for time-offset, block-based intermediate storage of the intensity vectors; and
means for forming vectors from the particular current intensity vector and from the time-offset intensity vector acquired before the particular current and intermediately stored intensity vector, the two vectors deriving from the same location in the specimen,
are provided.

25. The arrangement as defined in claim 24, wherein means are provided for analyzing the slopes of the code book vectors, in order to ascertain and display on the visual depiction means the bleaching behavior or influences of active setting parameters.

26. The arrangement as defined in claim 15, wherein
means for calculating a correction matrix from the code book vectors; and
means for applying the correction matrix to the currently measured intensity vectors with simultaneous image construction
are provided.

27. An system for ascertaining process variables in a microscope system comprises a scanning microscope that guides a light beam in parallel or sequential fashion over a specimen; multiple detectors that ascertain, from the light emerging from the specimen, intensities from different spectral regions; a processing unit; a computer; and input unit; and a display, wherein
a) in the processing unit, means for combining into one intensity vector the intensities (I₁, I₂, . . . Iₙ) ascertained by detectors (19) from different spectral regions of a measurement operation;
b) means for calculating a norm of the intensity vector;
c) means for discarding those intensity vectors whose norm is less than a definable threshold value (SW);
d) means for normalizing the intensity vectors;
e) a vector quantizer that processes the intensity vectors; and
f) means for reading code book vectors out of the vector quantizer
are provided.

28. The system as defined in claim 27, wherein the normalizing means perform the calculation of the Euclidean distance to a coordinate origin.

29. The system as defined in claim 27, wherein the vector quantizer is embodied as a “learning vector quantizer” or as a competitively learning neural network, or can be derived or inferred therefrom in the context of mathematical approximation.

30. The system as defined in claim 27, wherein
means for selecting a subset from the plurality of code book vectors; and
means for conveying the selected code book vectors to an analysis and visualization unit
are provided.

31. The system as defined in claim 30, wherein the visualization unit is a display on which, in at least one window, the code book vectors can be depicted visually in a coordinate system.

32. The system as defined in claim 30, wherein a multi-band detector is provided that performs an automatic adjustment on the basis of the ascertained crosstalk in order to minimize the crosstalk of the individual detection channels, a selection of the subset of the code book vectors being limited to those code book vectors located nearest to the axes of a coordinate system, each coordinate axis representing detection in one detection channel; and the slope of the code book vectors with respect to the coordinate axes and to each other can be employed to ascertain the crosstalk of the individual detection channels.

33. The system as defined in claim 30, wherein the axes of the coordinates can be depicted in triple fashion, and the code book vectors located nearest to said axes can be plotted, on the display.

34. The system as defined in claim 30, wherein the axes of the coordinate system can be visually depicted in pairs, and the code book vectors located nearest to said axes can be plotted, on the display.

35. The system as defined in claim 30, wherein a counter that verifies the significance of the signal component represented by the particular code book vector is allocated to each visual depiction of the axes of the coordinate system on the display.

36. The system as defined in claim 27, wherein
means for acquiring the local coordinates of a specimen during the scanning operation, and the intensities associated with the local coordinates;
means for comparing the intensity vectors to the code book vectors; and
means for classifying the intensity vectors onto the nearest code book vector
are provided.

37. The system as defined in claim 27, wherein
means for time-offset, block-based intermediate storage of the intensity vectors; and
means for forming vectors from the particular current intensity vector and from the time-offset intensity vector acquired before the particular current and intermediately stored intensity vector, the two vectors deriving from the same location in the specimen,
are provided.

38. The system as defined in claim 37, wherein means are provided for analyzing the slope of the code book vectors, in order to ascertain and display on the display the bleaching behavior or influences of active setting parameters.

39. The system as defined in claim 27, wherein means for calculating a correction matrix from the code book vectors, and means for applying the correction matrix to the currently measured intensity vectors with simultaneous image construction, are provided.
